(19) United States
(12) Patent Application Publication
(10) Pub. No.: US 2007/0062085 A1
(43) Pub. Date: Mar. 22, 2007

(54) Sign panel arrangement with three-dimensional illumination effect

(76) Inventor: Frank Pan, Alhambra, CA (US)

Correspondence Address: Raymond Y. Chan, 108 N. Ynez Ave., #128, Monterey Park, CA, 91754, US

(21) Appl. No.: 11/218,414

(22) Filed: Sep. 1, 2005

(51) Int. Cl. G09F 13/18

(52) U.S. Cl. 40/546

(57) ABSTRACT

A sign panel arrangement includes at least two sign panels and an illumination system. The sign panels are overlapped in a side-by-side manner, wherein each of the sign panels has a light permeable portion and a light reflection portion. The illumination system includes a plurality of light sources aligned with the sign panels for generating light beams projecting thereto respectively, wherein the light permeable portion of each of the sign panels allows the respective light beam passing therethrough while the light reflection portion of each of the sign panels reflects respective light beam to create a planar light effect at each of the sign panels, such that the sign panels generate a multi-layering illumination to create a three dimensional illumination effect.

### BACKGROUND OF THE PRESENT INVENTION

1. Field of Invention

The present invention relates to an illumination system, and more particularly to a sign panel arrangement which is capable of generating planar light effect at each sign panel in a predetermined sequence so as to create a three-dimensional multi-layering illumination.

2. Description of Related Arts

Conventional illuminating signs have widely been utilized all over the world. There are basically two kinds of illuminating signs, viz. fluorescent lamps and LEDs signs panel. The former category of illuminating signs consumes a lot of energy, produces enormous amount of heat during operation so that it may not be suitable for certain users, and generally not durable when compared with LEDs signal panel. Moreover, fluorescent lamps are generally inflexible in that they may only be observed from a particular direction. One way of mitigating this difficulty is to utilize a light box having two opposed sign panels, wherein a plurality of fluorescent lamps are mounted within the light box so that the user may display two different patterns at the two sign panels respectively. However, the patterns displayed on this light box are usually inflexible in the sense that the patterns are usually standstill without any dynamic feature.

With regards to LEDs sign panels, they consume less energy, durable, and do not produce enormous amount of heat during operation. Another advantage of LEDs sign panels is that they are easily controlled by electronics components so that the patterns which they produce are generally more flexible and dynamic.

Despite its advantages, there exists a deep-seated problem of LEDs sign panel that the light intensity of LEDs is usually not strong enough so that handfuls of inventions have been developed in order to accumulate or reflect LEDs illumination to become a coherent and intense light source for use in displaying say, advertisement patterns. As a result, once LEDs illumination needs accumulatively reflecting, their applications are inevitably limited and become inflexible. For example, a sign panel may adopt a particular geometrical structure or shape so that the light illuminating from LEDs can be accumulatively reflected to produce a particular light effect.

A particular application of LEDs sign panel is to produce a flashing and dynamic pattern with different colors. One may utilize a plurality of LEDs which generate different colors and strategically positioned at predetermined points in the sign panel, wherein the LEDs may be controlled by sophisticated electrical circuits for controlling the order and the frequency of the operation of each of the LEDs in order to produce the particular light effect.

The problem then, is that the LEDs sign panel is complicated in geometrical structure and electrical connection between the LEDs. Moreover, for a particular pattern, one may not change the geometry of the sign panel because one may need a particular geometrical structure for effectively carrying out accumulative reflection within the sign panel. As a result, because of the inherent disadvantage of LEDs, namely, inadequate light intensity, their applications are severely limited. Another problem with this complicated geometry and electrical connections between LEDs is that the manufacturing cost as well as the ultimate selling price of this kind of LEDs sign panel would be very high. To conclude therefore, the advantages of LEDs are severely balanced, if not altogether outweighed, by their disadvantage, so that breakthrough in this area of technology is needed.

Last but not least, even though one may overcome or tolerate the problem of complicated geometrical structure as well as electrical connections, there is one effect which LEDs can not generally achieve, namely, to produce an illumination pattern having three-dimensional illumination effect. As a matter of fact, virtually all LEDs sign panel is planar in structure so that what the LEDs produce is essentially a two-dimensional pattern, albeit one may view the pattern from different angles. Previous efforts have not been addressed to resolve of this disadvantage.

### SUMMARY OF THE PRESENT INVENTION

A main object of the present invention is to provide a sign panel arrangement which is capable of generating planar light effect at each sign panel in a predetermined sequence so as to create a three-dimensional multi-layering illumination.

Another object of the present invention is to provide a sign panel arrangement comprising a plurality of light sources arranged in a simple array for providing three-dimensional multi-layering illumination for a sign panel. In other words, simple arrangement of light sources are utilized to generate three-dimensional, dynamic, and sophisticated lighting effect.

Another object of the present invention is to provide a sign panel arrangement which is compatible with a wide variety of light sources so as to promote widespread applications of the present invention. For example, the light sources may be embodied as LEDs for resolve the above-mentioned disadvantages. Alternatively, the light sources may be embodied as optical fibers extended from a wide variety of illuminating objects.

Another object of the present invention is to provide a sign panel arrangement which does not involve complicated mechanical or electrical components so as to minimize the manufacturing cost as well as the ultimate selling price of the present invention.

Accordingly, the present invention provides a sign panel arrangement, comprising:

at least two sign panels overlapped in a side-by-side manner, wherein each of the sign panels, having a predetermined thickness, has a light permeable portion and a light refraction portion, and

an illumination system which comprises a plurality of light sources aligned with the sign panels for generating light beams projecting thereto respectively, wherein the light permeable portion of each of the sign panels allows the respective light beam passing therethrough while the light refraction portion of each of the sign panels reflects respective light beam to create a planar light effect at each of the sign panels, such that the sign panels generate a multi-layering illumination to create a three dimensional illumination effect.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a sign panel arrangement according to a preferred embodiment of the present invention.

FIG. 2 is an exploded perspective view of the sign panel arrangement according to the above preferred embodiment of the present invention.

FIG. 3 is a sectional side view of the sign panel arrangement according to the above preferred embodiment of the present invention.

FIG. 4 is a sectional side view of the supporting base according to the above preferred embodiment of the present invention

FIG. 5 is a first schematic diagram of the sign panel arrangement according to the above preferred embodiment of the present invention.

FIG. 6 is a second schematic diagram of the sign panel arrangement according to the above preferred embodiment of the present invention

FIG. 7 is an alternative mode of the sign panel arrangement according to the above preferred embodiment of the present invention.

### DETAILED DESCRIPTION OF THE PREFERRED EMBODIMENT

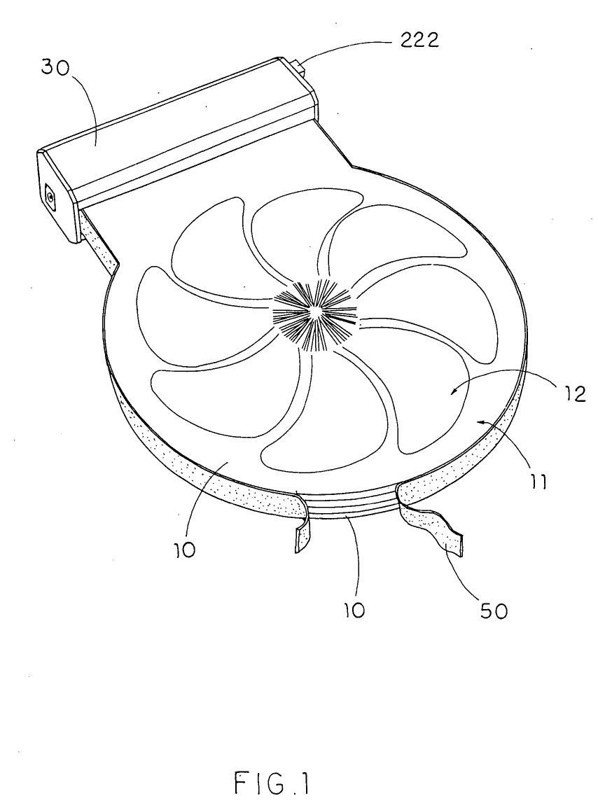

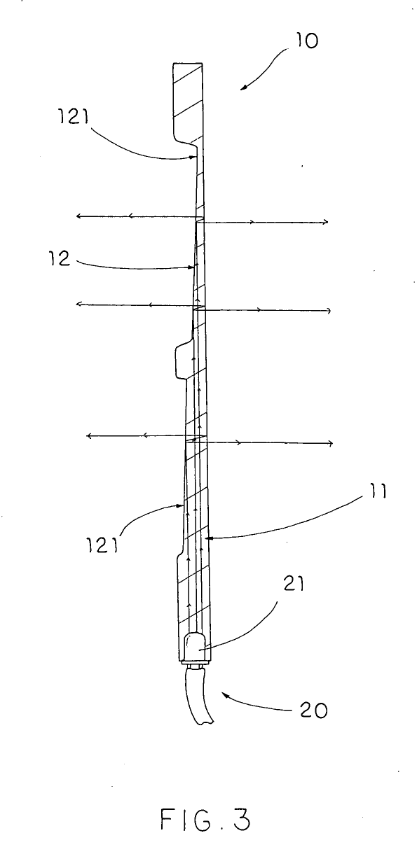

Referring to FIG. 1 to FIG. 3 of the drawings, a sign panel arrangement according to a preferred embodiment of the present invention is illustrated, in which the sign panel arrangement comprises a plurality of sign panels 10, and an illumination system 20.

The sign panels 10 are overlapped in a side-by-side manner, wherein each of said sign panels 10 has a light permeable portion 11 having a predetermined light transmissivity, and a light reflection portion 12 having a predetermined refractive index for reflecting the light illuminating from the illumination system 20.

The illumination system 20 comprises a plurality of light sources 21 aligned with the sign panels 10 for generating light beams projecting thereto respectively, wherein the light permeable portion 11 of each of the sign panels 10 allows the respective light beam passing therethrough while the light reflection portion 12 of each of the sign panels 10 reflects respective light beam to create a planar light effect at each of the sign panels 10, such that the sign panels 10 generate a multi-layering illumination to create a three dimensional illumination effect.

According to the preferred embodiment of the present invention, the sign panel arrangement further comprises a supporting base 30 which is arranged to support the sign panels 10 standing in an upright manner above the supporting base 30 for providing the three-dimensional illumination effect. More specifically, the supporting base 30, having an elongated structure, has a receiving cavity 31 and a retaining slot 32 extended on top and along the supporting base 30, wherein lower portions of the sign panels 10 are arranged to receive into the receiving cavity 31 via the retaining slot 32 so as to be uprightly retained and supported at the mounting base 30 for providing the three-dimensional illumination effect.

Referring to FIG. 1 to FIG. 4 of the drawings, the sign panels 10 are uprightly supported on the mounting base 30 wherein the illumination system 20 is provided in the supporting housing 10 for generating illumination upwardly towards the relevant sign panels 10. The light permeable portion 11 of each of the sign panels 10 allows light to pass therethrough, while the light reflection portion 12 of each of the sign panels 10 is arranged in such a manner that when light beam passes from the light permeable portion 11 to the light reflection portion 12, a predetermined portion of the light beam will be deflected to propagate towards a front or a rear side of the respective sign panel 10 for creating the planar light effect.

According to the preferred embodiment of the present invention, the light permeable portion 11 are embodied as having a cross section which has non-uniform thickness to create refraction at the light reflection portion 12 for deflecting the light beam originated from the illumination system 20. For example, an upper portion of the light permeable portion 11 may have a thickness larger than that of its lower portion, so that when the light passes from the bottom of the sign panel 10 to the light reflection portion 12, it will deflect at the light reflection portion 12 because there is a change of refractive index between two sides of the light reflection portion 12.

In other words, a thickness of the light permeable portion 11 of each of the sign panel 10 is larger than the thickness of the light refraction portion 12 thereof to form an indent light refraction surface 121 such that when the light beam passes through the light permeable portion 11 to the light refraction portion 12, the light beam is refracted at the light refraction surface 121 in a transverse direction to create the planar illumination effect. More specifically, the thickness of the light refraction portion 12 at a position close to the light source 21 may be larger than the thickness of the light refraction portion 12 at a position far away from the corresponding light source 21 such that the light reflection portion 12 is capable of deflecting the light from the relevant light source 21 to create the planar illumination effect at the light reflection surface.

Alternatively, the light permeable portion 11 may be made of different materials having different refractive indexes for allowing the refraction to take place at the boundary between two different materials. In this scenario, the light reflection portion 12 is embodied as the boundary between two different materials as well as an outer peripheral surface of the light permeable portion 11. It is worth mentioning that each of the sign panels 10 may be made by different materials as well as having a cross section having non-uniform thickness. In either way however, the sign panels 10 are shaped and crafted to form a predetermined sign which is to be highlighted in a controlled and dynamic manner by the illumination system 20 for producing the three-dimensional illumination effect.

For example, the light permeable portion 11 of each of the sign panels has a density different from a density of the light refraction portion 12 thereof such that when the light beam passes through the light permeable portion 11 to the light refraction portion 12, the light beam is refracted at the light refraction portion 12 in a transverse direction to create the planar illumination effect.

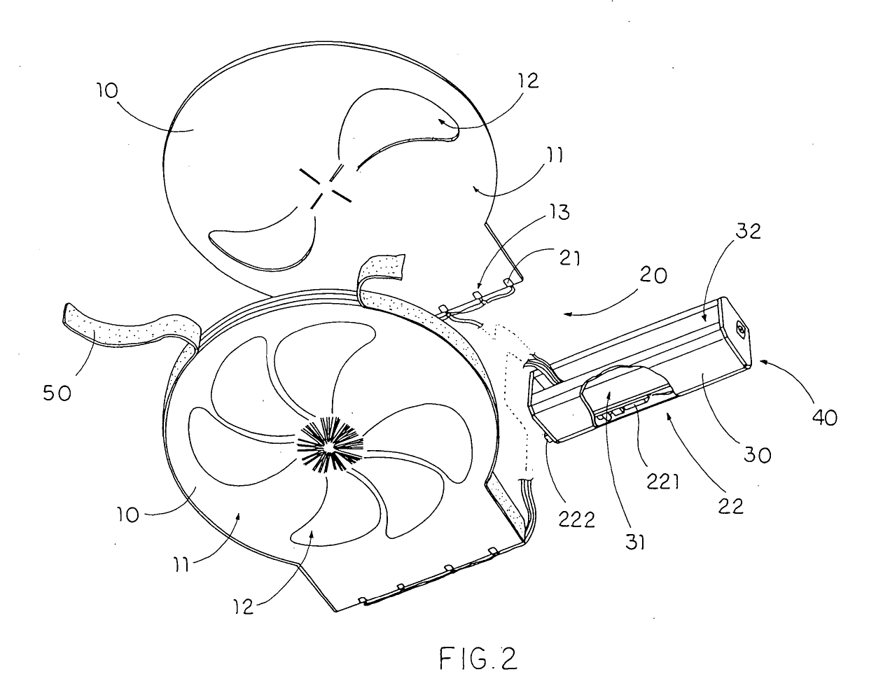

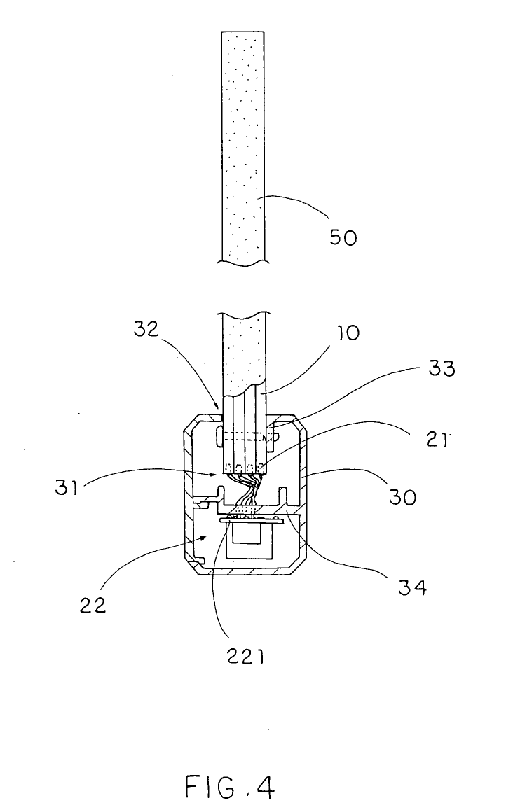

Referring to FIG. 2 and FIG. 4 of the drawings, the illumination system 20 further comprises a control unit 22 electrically connected with the light sources 21 to regulate an order of operation thereof. According to the preferred embodiment of the present invention, the light sources 21 are embodied as LEDs mounted in the receiving cavity 31 of the supporting base 30 in an array for generating illumination towards the sign panels 10 in a predetermined order so as to create the three-dimensional illumination effect. Accordingly, the control unit 22 comprises a control circuitry 221 mounted in the mounting base 30 to electrically connect with the LEDs for controlling an operation thereof.

Each of the sign panels 10 has a retaining cavity 13 formed along a peripheral edge thereof to receive the respective light source 21 in the retaining cavity 13 so as to guide the light beam propagating towards the light refraction portion 12 of the respective sign panel 10 through the permeable portion 11 thereof to create the planar illumination effect.

In order to effectively create the planer illumination effect for each of the sign panels 10, each of the sign panels 10 has a plurality of retaining cavities 13 formed along a peripheral edge thereof so as to guide the light beam propagating towards the light refraction portion 12 of the respective sign panel through the permeable portion 11 thereof to create the planar illumination effect. As a result, a corresponding number of the light sources 21 are fittedly embedded in the retaining cavities 13 to generate the light beam upwardly towards the light reflection portion 12 for creating the planar illumination effect.

Accordingly, each of the light sources 21 is shaped and sized to fittedly receive into the corresponding retaining cavity 13 for generating the light beam. As a result, each of the light sources 21, i.e. the LEDs is specifically shaped to correspond to the thickness of the corresponding sign panel 10 so that the light source 21 is capable of being fittedly received into the corresponding retaining cavity 13. In other words, the light sources 21 are supported at the supporting base 30 within the retaining cavities 13, wherein the light panels 10 are mounted in the side-by-side manner for forming the array of light sources 21 to produce the planar illumination effect at the corresponding sign panel 10. As a result, the LEDs are embedded in the peripheral edges of the sign panels 10, wherein each of the LEDs has a size at least smaller than the thickness of each of the sign panels 10.

The control unit 22 further comprises a control panel 222 provided on the supporting base 30 to electrically connect with the control circuitry 221, wherein the control panel 222 is adapted to be actuated for actuating the control circuitry 221 to operate the light sources 21 in a controlled manner. Accordingly, the control circuitry 221 is pre-programmed to operate the light sources 21 in the above-mentioned order in accordance with the program in the control circuitry 221.

In order to securely support the sign panels 10 and the illumination system 20 while allowing effective discharge of their respective function, the supporting base 30 further comprise two mounting walls 33 vertically extended in the receiving cavity 31 as two sidewalls of the retaining slot 32 respectively, wherein the sign panels 10, being overlapped in the side-by-side manner, are arranged to be partially received in the retaining slot 32 and securely mounted on the two mounting walls 33 in the upright manner. As a result, the sign panels 10 are securely supported by the mounting base 30 for creating the three-dimensional illumination effect.

The mounting base 30 further comprises a divider 34 extended along the mounting base 30 to divide the receiving cavity 31 into an upper partition and a lower partition, wherein the sign panels 10 are mounted on mounting walls 33 at the upper partition, while the control circuitry 221 is securely supported in the lower partition for electrically connecting with the light sources 21, preferably through a plurality of wires penetrating through the divider 34. It is worth mentioning that the sign panels 10 are mounted in the upper partition at a position space apart from the divider 34 so that the electrical connections between the light sources 21 and the control unit 22 can be effectively accomplished without any tangling or inadequate space for receiving any associated electronics components, such as resistors, mounting with the light sources 21.

In order to operate the control unit 22 as well as the illumination system 20, the sign panel arrangement further comprises a power system 40 electrically connected with the control unit 22 and the light sources 21 for providing power to operate the control unit 22 and the light sources 21. According to the preferred embodiment, the power system 40 comprises a power inlet 41 and a power adaptor electrically connecting with the illumination system 20, wherein the power inlet 41 is adapted for electrically connecting with an external power source, such as an AC power plug, for acquiring electrically energy. The power adaptor then converts the externally acquired electricity into predetermined voltage and current for use by the illumination system 20. It is then worth mentioning that the power adaptor may be built-in on the control circuitry 221 as well so that the power acquired via the power inlet 41 is transmitted to the control circuitry 221 for voltage adjustment by the power adaptor.

As an alternative of the power system 40, it may be embodied as a rechargeable battery supported within the supporting base 30 for providing electrical power to the illumination system 20.

Referring to FIG. 1 of the drawings, according to the preferred embodiment of the present invention, the sign panels 10 form a radially extending figure by the light reflection surfaces 12 and the light preamble portions 12, wherein control circuitry 221 is programmed to operate the light sources 21 in such a manner that the light sources 21 embedded on each sign panel 10 is sequentially illuminated so as to sequentially create the planar illumination effect for each sign panel 10. As a result, the radially extending figure is sequentially highlighted at different portions thereof in a clockwise or anti-clockwise direction so that an ordered illumination of the light sources 21 eventually creates a rotating and dynamic illumination pattern on the sign panels 10 as the three-dimensional illumination effect.

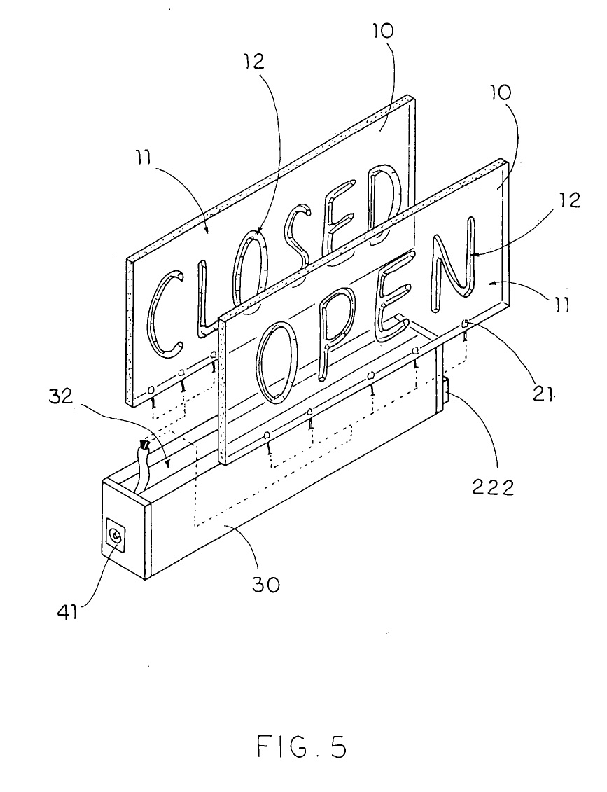

Having said these, it is worth emphasizing that the sign panel arrangement of the present invention is capable of forming a wide variety of different embodiments for use in a wide variety of different circumstances. Referring to FIG. 5 of the drawings, the sign panels 10 may be embodied as forming an ‘OPEN’ sign so that when the light sources 21 are illuminating as controlled by the control unit 22, the ‘OPEN’ sign will deliver the three-dimensional illumination effect and the four letters are sequentially highlighted for creating a dynamic light effect.

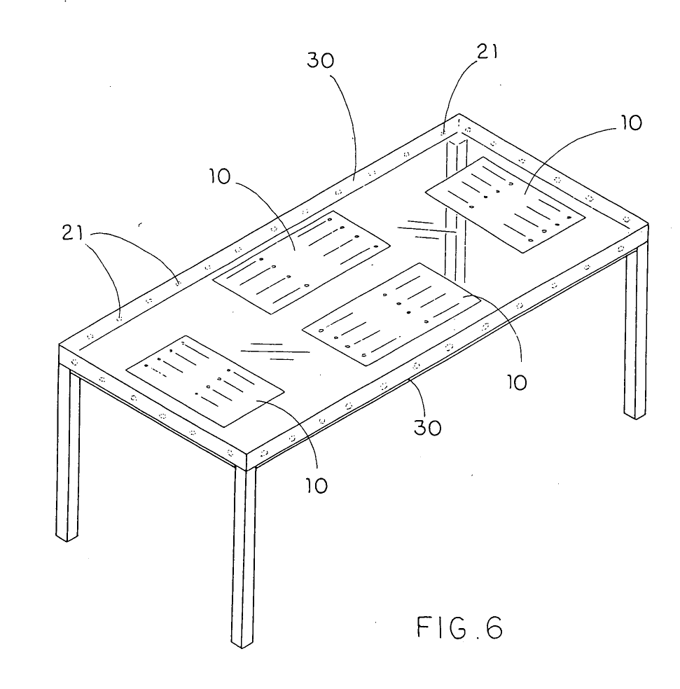

Alternatively, as shown in FIG. 6 of the drawings, the sign panel arrangement may be utilized as a tabletop in which the sign panels 10 may be embodied as showing predetermined figures or say, menus on the tabletop. Since the light sources 21 are embodied as LEDs, they will not generate large amount of heat so as to ensure that those who are using the tabletop for, say dining, are safe. As further examples, the sign panel arrangement may also be embodied as a screen or illuminating floor tiles for use in domestic or business environment.

In order to further enhance the three-dimensional illumination effect of the present invention, the sign panel arrangement further comprises a light retention layer 50 formed along an outer surrounding edge of each of the sign panels 10 to reflect the light beam back to the respective sign panel 10. As such, the light beam reaching the light reflection portion 12 will not escape from the outer surrounding edge of the sign panel and must be more coherent for creating the three-dimensional illumination effect.

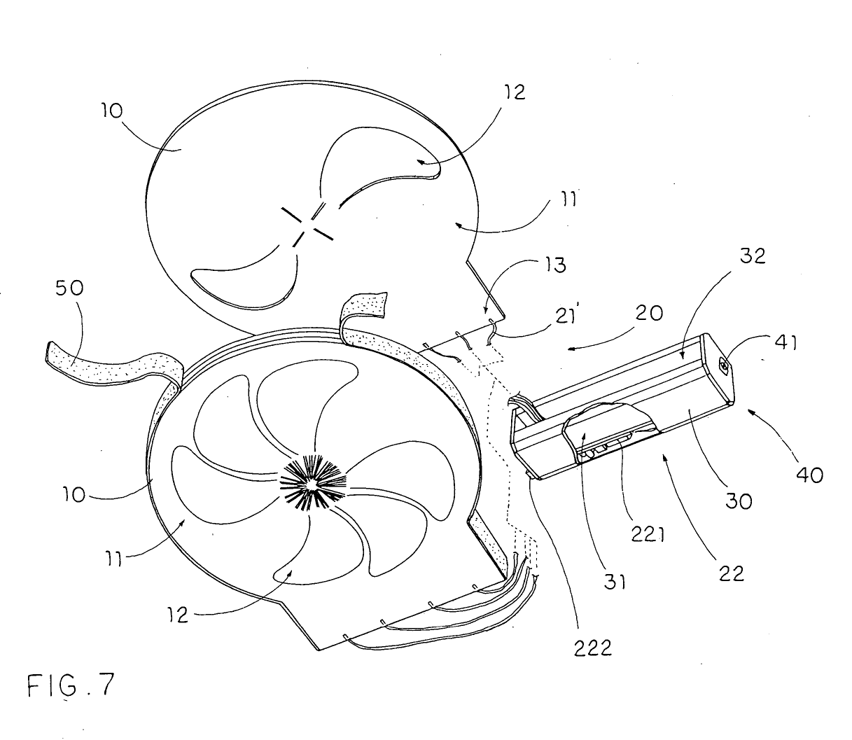

Referring to FIG. 7 of the drawings, an alternative mode of the sign panel arrangement according to the preferred embodiment of the present invention is illustrated. The alternative mode is similar to the preferred embodiment except that the light sources 21′ are embodied as optical fibers which are extended to external optical sources for providing illumination. As such, the thickness of the sign panels can be minimized in that this alternative mode does not require LEDs to be embedded into the sign panels 10.

From the forgoing descriptions, it can be shown that the above objects have been substantially accomplished. The present invention provides a sign panel arrangement which is capable of generating planar light effect at each sign panel in a predetermined sequence so as to create a three-dimensional multi-layering illumination. The present invention is economical to manufacture and easy to use.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A sign panel arrangement, comprising:
at least two sign panels overlapped in a side-by-side manner, wherein each of said sign panels, having a predetermined thickness, has a light permeable portion and a light refraction portion, and
an illumination system which comprises a plurality of light sources aligned with said sign panels for generating light beams projecting thereto respectively, wherein said light permeable portion of each of said sign panels allows said respective light beam passing therethrough while said light refraction portion of each of said sign panels reflects respective light beam to create a planar light effect at each of said sign panels, such that said sign panels generate a multi-layering illumination to create a three dimensional illumination effect.

2. The sign panel arrangement, as recited in claim 1, wherein a thickness of said light permeable portion of each of said sign panel is larger than said thickness of said light refraction portion thereof to form an indent light refraction surface such that when said light beam passes through said light permeable portion to said light refraction portion, said light beam is refracted at said light refraction surface in a transverse direction to create said planar illumination effect.

3. The sign panel arrangement, as recited in claim 2, wherein said thickness of said light refraction portion at a position close to said light source is larger than said thickness of said light refraction portion at a position far away from said light source.

4. The sign panel arrangement, as recited in claim 1, wherein said light permeable portion of each of said sign panels has a density different from a density of said light refraction portion thereof such that when said light beam passes through said light permeable portion to said light refraction portion, said light beam is refracted at said light refraction portion in a transverse direction to create said planar illumination effect.

5. The sign panel arrangement, as recited in claim 1, wherein each of said sign panels has a retaining cavity formed along a peripheral edge thereof to receive said respective light source in said retaining cavity so as to guide said light beam propagating towards said light refraction portion of said respective sign panel through said permeable portion thereof to create said planar illumination effect.

6. The sign panel arrangement, as recited in claim 2, wherein each of said sign panels has a retaining cavity formed along a peripheral edge thereof to receive said respective light source in said retaining cavity so as to guide said light beam propagating towards said light refraction portion of said respective sign panel through said permeable portion thereof to create said planar illumination effect.

7. The sign panel arrangement, as recited in claim 3, wherein each of said sign panels has a retaining cavity formed along a peripheral edge thereof to receive said respective light source in said retaining cavity so as to guide said light beam propagating towards said light refraction portion of said respective sign panel through said permeable portion thereof to create said planar illumination effect.

8. The sign panel arrangement, as recited in claim 4, wherein each of said sign panels has a retaining cavity formed along a peripheral edge to receive said respective light source in said retaining cavity so as to guide said light beam propagating towards said light refraction portion of said respective sign panel through said permeable portion thereof to create said planar illumination effect.

9. The sign panel arrangement, as recited in claim 1, wherein said light sources are a plurality of LEDs embedded in said peripheral edges of said sign panels, wherein each of said LEDs has a size at least smaller than said thickness of each of said sing panels.

10. The sign panel arrangement, as recited in claim 7, wherein said light sources are a plurality of LEDs embedded in said peripheral edges of said sign panels, wherein each of said LEDs has a size at least smaller than said thickness of each of said sing panels.

11. The sign panel arrangement, as recited in claim 8, wherein said light sources are a plurality of LEDs embedded in said peripheral edges of said sign panels, wherein each of said LEDs has a size at least smaller than said thickness of each of said sing panels.

12. The sign panel arrangement, as recited in claim 1, wherein said light sources comprises a plurality of optical fibers extended from a light beam generator to said peripheral edges of said sign panels to transmit said light beams thereto, so as to minimize said thickness of each of said sign panels.

13. The sign panel arrangement, as recited in claim 7, wherein said light sources comprises a plurality of optical fibers extended from a light beam generator to said peripheral edges of said sign panels to transmit said light beams thereto, so as to minimize said thickness of each of said sign panels.

14. The sign panel arrangement, as recited in claim 8, wherein said light sources comprises a plurality of optical fibers extended from a light beam generator to said peripheral edges of said sign panels to transmit said light beams thereto, so as to minimize said thickness of each of said sign panels.

15. The sign panel arrangement, as recited in claim 5, further comprising a supporting base having a retention slot substantially holding said peripheral edges of said sign panels and a control circuitry which is received in said supporting base and is electrically connected to said light sources to operate said light sources in a pre-programmed manner so as to create different planar light effects at said sign panels.

16. The sign panel arrangement, as recited in claim 6, further comprising a supporting base having a retention slot substantially holding said peripheral edges of said sign panels and a control circuitry which is received in said supporting base and is electrically connected to said light sources to operate said light sources in a pre-programmed manner so as to create different planar light effects at said sign panels.

17. The sign panel arrangement, as recited in claim 7, further comprising a supporting base having a retention slot substantially holding said peripheral edges of said sign panels and a control circuitry which is received in said supporting base and is electrically connected to said light sources to operate said light sources in a pre-programmed manner so as to create different planar light effects at said sign panels.

18. The sign panel arrangement, as recited in claim 1, further comprising a light retention layer formed along an outer surrounding edge of each of said sign panels to reflect said light beam back to said respective sign panel.

19. The sign panel arrangement, as recited in claim 16, further comprising a light retention layer formed along an outer surrounding edge of each of said sign panels to reflect said light beam back to said respective sign panel.

20. The sign panel arrangement, as recited in claim 17, further comprising a light retention layer formed along an outer surrounding edge of each of said sign panels to reflect said light beam back to said respective sign panel.
